(19) United States
(12) Patent Application Publication
(10) Pub. No.: US 2026/0159759 A1
(43) Pub. Date: Jun. 11, 2026

(54) DUAL CHANNEL SHAPE-CHANGING FIBER

(71) Applicant: Toyota Motor Engineering & Manufacturing North America, Inc., Plano, TX (US)

(72) Inventors: Yuyang Song, Ann Arbor, MI (US); Mingzhe Li, Atlanta, GA (US); Shinnosuke Shimokawa, Ann Arbor, MI (US); Hang Qi, Marietta, GA (US)

(73) Assignees: Toyota Motor Engineering & Manufacturing North America, Inc., Plano, TX (US); Toyota Jidosha Kabushiki Kaisha, Toyota-shi Aichi-ken (JP); Georgia Tech Research Corporation, Atlanta, GA (US)

(21) Appl. No.: 18/973,221

(22) Filed: Dec. 9, 2024

(51) Int. Cl. C09K 19/38

(52) U.S. Cl. CPC C09K 19/38; C09K 2219/01

(57) ABSTRACT

Shape-changing fibers, methods and other embodiments described herein relate to a dual channel shape-changing fiber. In one embodiment, a shape-changing fiber includes a longitudinal body of a liquid crystal elastomer (LCE) material. A shape property of the LCE material reversibly changes responsive to an activation input. The shape-changing fiber also includes 1) a first channel formed longitudinally within the longitudinal body and 2) a second channel formed longitudinally within the longitudinal body. The first channel and the second channel are parallel to one another.

### TECHNICAL FIELD

The subject matter described herein relates, in general, to shape-changing fibers and, more particularly, to shape-changing fibers with multiple channels that can be filled with different materials, sometimes in a segmented arrangement, to generate a customized and complex bending motion.

### BACKGROUND

An actuator is a mechanical device that achieves physical movement. Actuators come in a variety of forms and are widely used in many industries across the globe. For example, actuators may be found in robotic devices. In one particular example, actuators may be found in biomimetic devices that attempt to emulate or replicate processes found in nature. However, replicating complex and naturally occurring animal and/or human motion may be difficult. For example, some actuators are formed of metal and/or plastic structures with mechanical linkages and joints. Other robotic devices, such as soft robotic devices, utilize flexible materials like silicone rubber to replicate the motion of the human hand and/or fingers.

### SUMMARY

In one embodiment, example systems and methods relate to a manner of generating complex non-linear automated movements of an actuator.

In one embodiment, a shape-changing fiber is disclosed. The shape-changing fiber includes a longitudinal body of a liquid crystal elastomer (LCE) material. A shape property of the LCE material reversibly changes responsive to an activation input. The shape-changing fiber also includes a first channel formed longitudinally within the longitudinal body and a second channel formed longitudinally within the longitudinal body. The first channel and the second channel are parallel to one another.

In one embodiment, a shape-changing fiber is disclosed. The shape-changing fiber includes a longitudinal body of an LCE material. A shape property of the LCE material reversibly changes responsive to an activation input. The shape-changing fiber also includes a first channel formed longitudinally within the longitudinal body and a second channel formed longitudinally within the longitudinal body. The first channel and the second channel are parallel to one another. The shape-changing fiber also includes shape memory material (SMM) within the first channel. A shape property of the SMM reversibly changes responsive to the activation input to a different degree than the shape property of the LCE material.

In one embodiment, a method for forming a shape-changing fiber is disclosed. In one embodiment, the method includes simultaneously 1) drawing an LCE material through an outer aperture of a multi-aperture nozzle to form a longitudinal body and 2) passing a sacrificial fluid through a first inner aperture and a second inner aperture of the multi-aperture nozzle to form inner channels within the longitudinal body. The outer aperture is coaxial to and surrounds the first inner aperture and the second inner aperture. A shape property of the LCE material reversibly changes responsive to an activation input. The method also includes curing the LCE material and removing the sacrificial fluid from a first channel and a second channel.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is an isometric view of the shape-changing fiber in accordance with an embodiment described herein.

FIGS. 2A-2D are cross-sectional side views of a shape-changing fiber with SMM and an activating material within the channels in accordance with an embodiment described herein.

FIGS. 3A and 3B are cross-sectional side views of a shape-changing fiber with SMM in one channel in accordance with an embodiment described herein.

FIGS. 4A and 4B are cross-sectional side views of a shape-changing fiber with SMM in both channels in accordance with an embodiment described herein.

FIG. 5 illustrates a flowchart for one embodiment of a method that is associated with forming a dual channel-shape changing fiber in accordance with an embodiment described herein.

FIGS. 6A-6C illustrate a manufacturing system for forming a dual channel shape-changing fiber in accordance with an embodiment described herein.

FIG. 7 illustrates a flowchart for one embodiment of a method that is associated with forming a dual-channel shape-changing fiber in accordance with an embodiment described herein.

FIG. 8 is an isometric view of the shape-changing fiber with hollow SMM in accordance with an embodiment described herein.

FIG. 9 is a graph depicting the storage modulus of a shape-changing fiber with SMM disposed therein.

### DETAILED DESCRIPTION

As described above, actuators are any mechanical or electromechanical device that generates physical movements. Over time, technological developments have produced actuators that can perform complex physical movements. However, some complex maneuvers are still difficult to replicate. As described above, biomimetics is a field of science that studies the motion of living organisms, such as humans, and develops devices that emulate, replicate, or mimic that motion. In one example, efforts have been made to replicate the movement of a human finger, particularly multiple human fingers, to replicate complex gripping motions. However, this endeavor is fraught with challenges. For example, rigid linkages and hinges are bulky, heavy, and complex and may not replicate a human hand's contoured curvilinear grip movement. Other devices, known as soft robotic devices, use soft materials, such as silicon rubber, to replicate this motion. Silicon rubber devices may not provide sufficient stiffness to grasp an object.

While particular reference is made to robotics, mechanical and/or electromechanical reproduction of certain movements/positions in other applications may be difficult. Another example is in the medical industry. For example, at one point in time, it may be desirable for a surgical device to have a straight configuration, such as to thread through a narrow canal. Following this, it may be desirable for the surgical device to have a different shape, for example, a curved hook to wrap around an object within the canal. These are just a few examples where the physical demands of situations and tasks are complex. It does not take much effort to consider other environments where complex maneuvers may be desirable to perform a particular task.

Accordingly, the present specification describes an actuator that can exhibit complex physical movements, such as multi-curvature bent movements, into complex shapes (i.e., S-shapes or other curvilinear shapes). Specifically, the shape-changing fiber described herein includes a longitudinal body formed of a liquid crystal elastomer (LCE) material. The LCE material is a stimuli-responsive material whose shape and/or properties are altered when exposed to external stimuli, such as heat, light, electric or magnetic fields, and pressure, among others. Specifically, LCEs are composed of crosslinked polymer networks containing liquid crystalline (or mesogen) units. In an initial state, these mesogens may be aligned. When heated above an LCE transition temperature, T_{tLCE}, LCEs undergo a phase transition from a nematic state with aligned mesogens to an isotropic phase with disordered mesogens. The misalignment of the mesogens can cause a contraction of the longitudinal body. The mesogens are again aligned upon cooling, and the LCE longitudinal body recovers its original shape.

The shape-changing fiber has at least two longitudinal channels therein. A first longitudinal channel may be filled with a first shape-changing material, such as a shape memory material (SMM). In general, a shape memory material is any material that changes shape when an activation input, such as heat, is provided to the SMM. In this particular example, the SMM, which may initially be rigid, becomes more pliable and deformable when the activation input (e.g., heat) is provided. In other words, both the SMM and the LCE change properties when heated, albeit by different degrees. Given that the SMM and the LCE have different actuation strains (e.g., the LCE has an actuation strain of between 35% and 45%, and the SMM has an actuation strain of less than 3%), the longitudinal body exhibits a bending motion when heated. In this example, the LCE body material and the SMM within the channel are chemically bonded together through acrylate bonding.

Note that before heating, the SMM is in a rigid state, such that the longitudinal body may be generally inflexible and stiff. After heating past an SMM transition temperature, T_{tSMM}, the SMM changes from a rigid state to a deformable and pliable one. That is, at the SMM transition temperature, T_{tSMM}, the SMM goes through a phase change and/or crystal structure transformation (i.e., twinned martensite, detwinned martensite, and austenite), resulting in a change of the properties of the SMM. Specifically, upon reaching the SMM transition temperature, T_{tSMM}, the SMM changes state (i.e., from a rigid, stiff state to a deformable and pliable state). Upon further heating past the LCE transition temperature, T_{tLCE}, the LCE material contracts. Accordingly, when the longitudinal body is heated past these two temperatures, 1) the LCE longitudinal body contracts and 2) the SMM is pliable to allow the contraction. Again, as described above, given the disparate responses to the heating (i.e., the different actuation strains), the longitudinal body may bend when heated. The bending movement of the longitudinal body may be programmed via the location and size of a mass of SMM at particular locations within the first and/or second inner channel. The bending is also facilitated by the bonding between the LCE and the SMM via acrylate bonding. Were the LCE and SMM not bound, the SMM may slide translationally within the LCE body.

Following deformation, the longitudinal body may be allowed to cool 1) slowly and uniformly or 2) quickly and sequentially to either return the longitudinal body to its original undeformed shape or maintain the longitudinal body in a deformed state, respectively. Accordingly, the fiber is deformable and may be set or locked into a deformed state.

The SMM and LCE may be heated by the Joule effect. In an example where the longitudinal body is Joule heated, a conductive material such as liquid metal may be injected into one of the channels. In this example, the SMM and the LCE may be heated by the Joule effect by passing an electrical current through the liquid metal.

Accordingly, the present specification describes a programmable shape-changing LCE fiber with dual channels. During fabrication, a sacrificial material is pumped through two inner apertures, while the LCE material is pumped through an outer aperture that is coaxial and outside of the two inner apertures. The sacrificial material is evacuated once the fiber is shaped, leaving a hollow dual-channel LCE fiber. After removing the sacrificial material, different functional materials, such as liquid metal or SMM, are injected into the different channels. Different segments of each channel may be filled with different materials in different arrangements based on the desired shape for the shape-changing fiber. For example, the first channel may have segments filled with SMM and others that remain hollow. The second may have segments filled with SMM or liquid metal to generate different curvatures along the shape-changing fiber.

The customizable characteristic of this dual-channel shape-changing fiber provides exciting possibilities in various fields, including artificial muscles, soft robotics, wearable electronics, environmental monitoring, and biomedical engineering, as the fiber can provide programmable complex nonlinear movements and is lightweight, soft, and flexible.

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

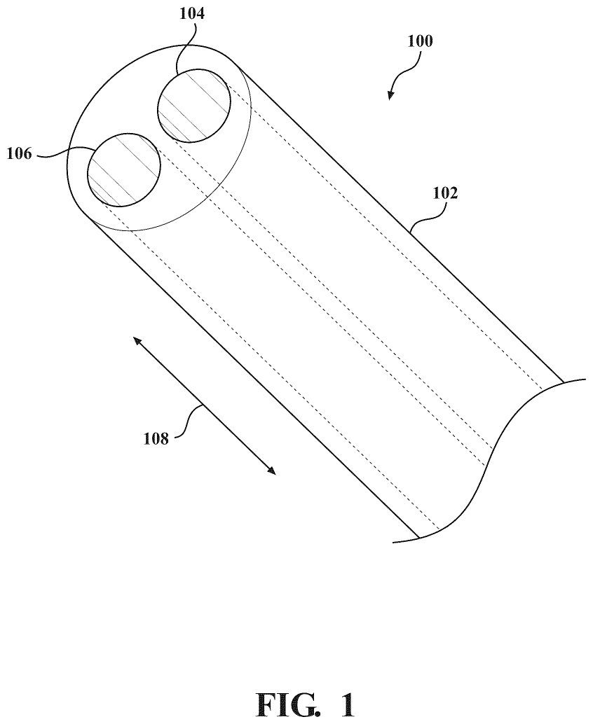

Turning now to the figures, FIG. 1 is an isometric view of the shape-changing fiber 100 in accordance with an embodiment described herein. The shape-changing fiber 100 may include a longitudinal body 102 formed of an LCE material. As described above, LCEs are soft stimuli-responsive materials formed from stiff mesogens bound to an elastomeric network of flexible polymer chains. Responsive to an external stimulus such as heat, light, and/or mechanical deformation, the mesogens of the LCE change from an aligned state to a misaligned state. This change in alignment allows the LCEs to undergo reversible phase transitions between the polydomain, monodomain, and isotropic states. The motion of the mesogens relative to the polymer network also enables the reversible actuation described herein in response to the activation input. That is, a shape property of the LCE material reversibly changes responsive to an activation input. Put another way, as described above, heat may cause the LCE material to transition from a nematic state with aligned mesogens to an isotropic state with misaligned mesogens. Due to this molecular re-alignment, the longitudinal body 102 may contract along a longitudinal length 108. Upon cooling, the mesogens re-align, and the LCE longitudinal body 102 recovers its original shape.

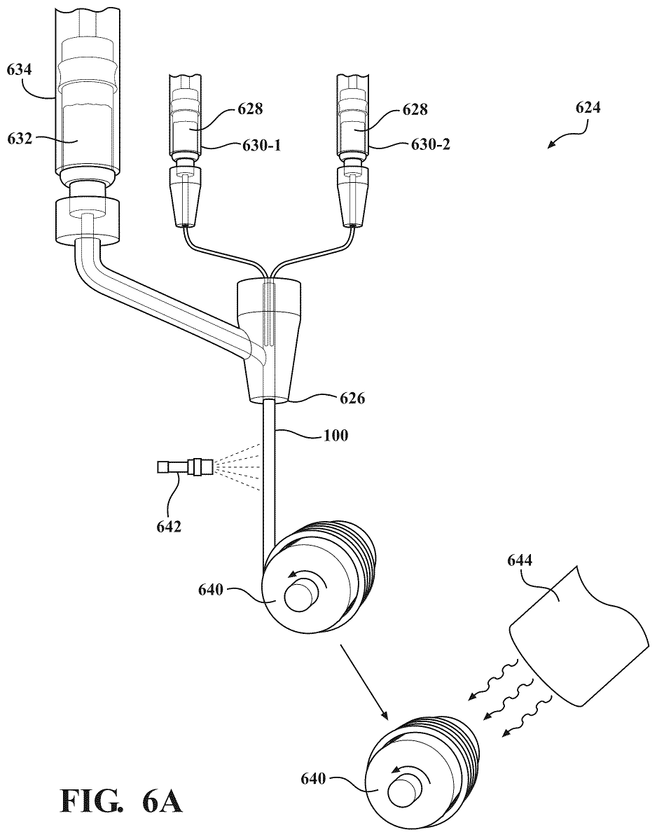

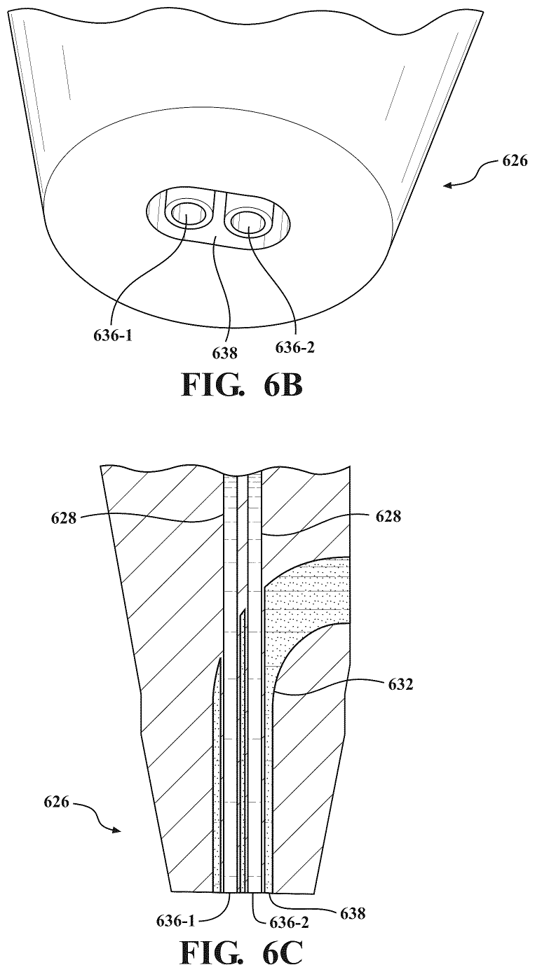

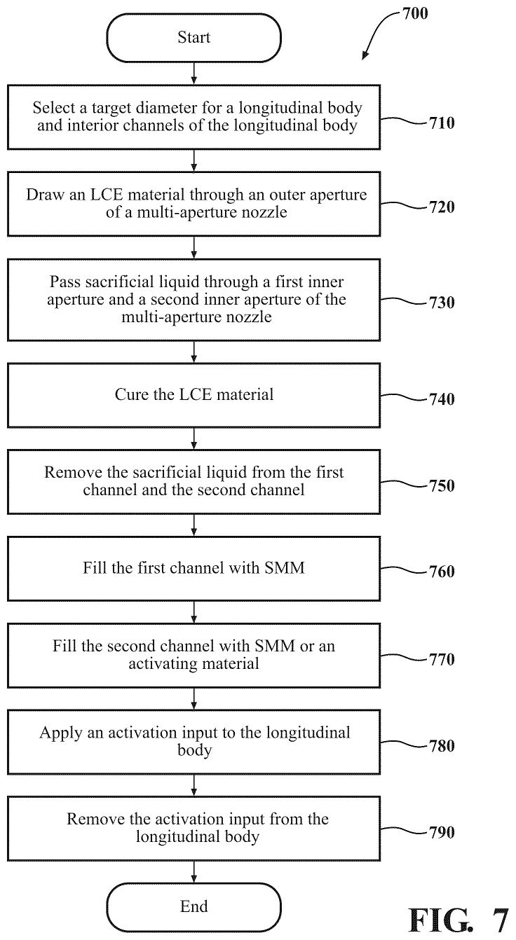

Note that while FIG. 1 depicts a particular cross-sectional shape of the longitudinal body 102 (i.e., ovular with minor and major diameters), the longitudinal body 102 may have a variety of cross-sectional shapes such as circular, square, or rectangular. The shape and dimensions of the longitudinal body 102 may be defined by the nozzle (as depicted in FIGS. 6A-6C) through which the LCE material is extruded during the formation of the shape-changing fiber 100 and various manufacturing parameters.

The longitudinal body 102 may have a variety of dimensions, for example, the longitudinal body may have a length on the order of micrometers up to and beyond three meters. In an example, the diameter of the longitudinal body 102 may be between 0.3 millimeters (mm) to 1.2 mm. As a specific example, a major diameter of an ovular longitudinal body 102 may be between 0.5 mm and 1.2 mm, and a minor diameter of the ovular longitudinal body 102 may be between 0.4 mm and 0.9 mm. However, while particular dimensions are provided for the longitudinal body 102, the longitudinal body 102 may have other ranges of dimensions as defined by the nozzle through which the LCE material is extruded.

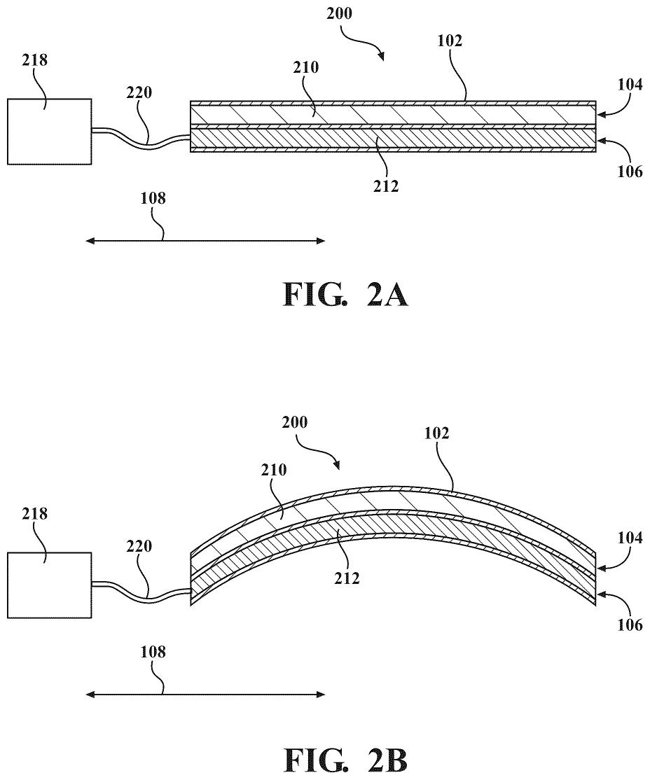

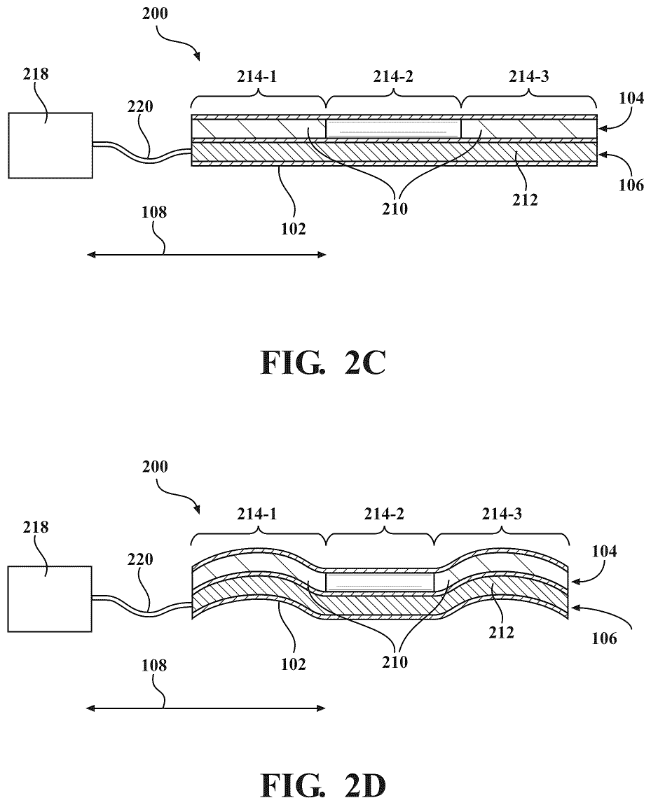

The shape-changing fiber 100 includes a first channel 104 formed longitudinally within the longitudinal body 102 and a second channel 106 formed longitudinally within the longitudinal body 102. As depicted in FIG. 1, the first channel 104 and the second channel 106 may be parallel to one another. In an example, each channel 104 and 106 may be filled with a different material, such as SMM or an activating material. The SMM facilitates 1) the bending actuation of the shape-changing fiber 100 as described in FIGS. 2A-4B) and 2) the locking of the shape-changing fiber 100 in a deformed (i.e., bent) configuration. As described below, the shape-changing fiber 100 may be programmed to exhibit a specific bending actuation based on the placement of “plugs” of SMM at different sections of the first channel 104 and/or the second channel 106.

The activating material, in one example, provides the activation input in the form of heat, which activation input alters 1) the state of the LCE material from the nematic state to the isotropic state and 2) the state of the SMM from a rigid state to a pliable state. Moreover, the SMM material also changes its physical form due to heat, specifically by contracting. Given the different responses of the SMM and the LCE material to the activation input, the application of the activation input generates a bending actuation/motion in the shape-changing fiber.

The shape and size of the channels 104 and 106 may vary and, as with the shape and size of the LCE material, may be defined by the nozzles through which a sacrificial fluid is passed. That is, as depicted in FIGS. 6A-6C , a sacrificial fluid is passed through the inner apertures of a multi-aperture nozzle. This sacrificial fluid, which is later removed once the LCE material is cured, forms the channels 104 and 106 of the shape-changing fiber 100. In an example, the diameter of the channels 104 and 106 may be between 0.15 mm and 0.5 mm. While particular dimensions are provided for the channels 104 and 106, the channels 104 and 106 may have other ranges of dimensions as defined by the nozzle through which the sacrificial fluid is ejected.

FIGS. 2A-2D are cross-sectional side views of a shape-changing fiber 200 with SMM 210 and an activating material within the channels 104 and 106 in accordance with an embodiment described herein.

As described above, in some examples, functional materials may be injected into the channels 104 and 106 to facilitate specific actuation properties. For example, the shape-changing fiber 200 may include SMM 210 within the first channel 104. As with the LCE material, a shape property of the SMM 210 reversibly changes responsive to the activation input. However, the shape property of the SMM 210 changes to a different degree than the shape property of the LCE material.

In general, SMM 210 is any material that changes shape when an activation input, such as heat, is provided to the SMM 210. In this particular example, the SMM 210 becomes more pliable and deformable when the activation input (e.g., heat) is provided. Examples of SMMs 210 include shape memory alloys (SMA) and shape memory polymers (SMP). The SMM 210 may be heated by the Joule effect. Upon reaching an SMM transition temperature, T_{tSMM}, the SMM 210 changes from a first state (i.e., generally rigid and stiff) to a second state (i.e., generally pliable and deformable). In an example, the SMM transition temperature, T_{tSMM}, may be between 20 and 120 degrees Celsius (C), based on the composition of the SMM. In one particular example, the SMM transition temperature, T_{tSMM}, is 60 C. While the SMM is in a second state, the shape-changing fiber 100 may be re-configured, which re-configuration may be triggered by 1) the provision of an activation input and 2) the disparate activation input responses of the SMM 210 and the LCE material as described below.

The SMM 210 may be structured such that when the activation input is removed, the SMM 210 returns to its original state, in this case, a rigid and stiff state. Accordingly, whether the shape-changing fiber 200 is an undeformed state, as depicted in FIG. 2A or in a deformed state, as depicted in FIG. 2B, the SMM 210, in its rigid and stiff state, locks the shape of the shape-changing fiber 200. The property of the SMM 210 to become pliable when heated facilitates the transitioning of the shape-changing fiber 200 between these two forms. Examples of SMM 210 include, but are not limited to, polytetrafluoroethylene (PFTE), polylactide (PLA), and ethylene-vinyl acetate (EVA), among others.

In an example, the activation input is heat that is generated by passing an electrical current through the shape-changing fiber 200. Specifically, the shape-changing fiber 200 may include an activating material such as liquid metal (LM) 212 within the second channel 106. In an example, the LM 212 may include conductive particles in a fluidic or semi-fluidic carrier. As described below, the LM 212 may be flowable or extrudable into the second channel 106. Examples of liquid metals include gallium, indium, and/or other metals or alloys of such. LM 212 may be selected as an activating material due to its conductivity, fluidity, and adaptability to various shapes, enabling the creation of an electrically driven soft actuator that retains the inherent flexibility of the LCE. However, while FIGS. 2A-2D specifically depict LM 212 as the activating material, the activating material may be a different material, such as a conductive polymer with conductive particles in a carrier material. For example, the activating material may be metal paste.

As described above, the SMM 210 may be heated by the Joule effect by passing an electrical current through the LM 212. The SMM 210 increases in temperature in response to the electrical current. That is, the SMM 210 heats up in response to the resistance of the LM 212 to the electrical current. In some implementations, the LM 212 receives the electrical current from a computing device and/or a power source. That is, the system may further include an electrical source 218 to apply the activation input to the activating material via, for example, an electrical trace 220. Upon reaching the SMM transition temperature, T_{tSMM}, the SMM 210 changes state (i.e., from a rigid, stiff state to a deformable and pliable state) as described above. The LM 212 produces Joule heat upon voltage application, elevating the temperature and inducing the shape-changing fiber 200 actuation. Overflow or leakage may be minimized due to the flexibility of both LCE and LM 212.

As depicted in FIG. 2B, the SMM 210 and the LCE material have different responses to the activation input. Specifically, LCE has a higher actuation strain than the SMM 210. As a specific example, the LCE may have an actuation strain of between 35-45%, and the SMM 210 may have an actuation strain of less than 3%. The LCE is also softer than the SMM 210, so when heated, the LCE material may bend/contract before the SMM 210. This disparate response between the LCE longitudinal body 102 and the SMM 210 in the first channel 104 and the chemical bonding (e.g., acrylate bonding) between the LCE longitudinal body 102 and the SMM 210 may cause the shape-changing fiber 200 to bend, as depicted in FIG. 2B. Put another way, the SMM 210 may resist the contraction of the adjacent LCE (i.e., the LCE that defines the walls of the first channel 104). As there is no SMM 210 in the second channel 106 to resist contraction, the portion of the LCE in the vicinity of the second channel 106 may contract more, and at a quicker rate, than the LCE in the vicinity of the first channel 104, leading to a bend in the shape-changing fiber 200 as depicted in FIG. 2B. Thus, the SMM 210 in the first channel 104 provides a customized bending actuation for the shape-changing fiber 200.

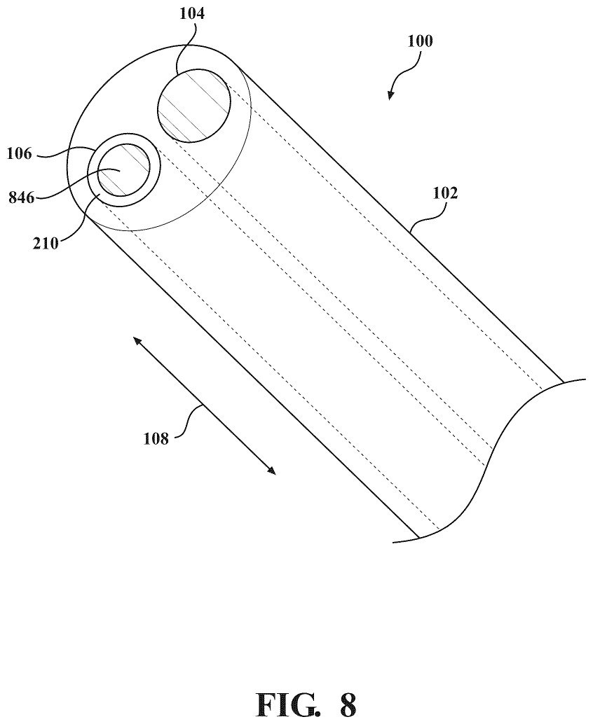

As described above, the bending actuation of the shape-changing fiber 200 may be customized based on the position of SMM 210 within the first channel 104. Accordingly, in an example, the SMM 210 may be formed in a first segmented arrangement within the first channel 104, including at least one hollow segment 214-2, as depicted in FIG. 2C. That is, the first channel 104 may be divided into segments 214-1, 214-2, and 214-3. SMM 210 may be injected into different segments 214-1 and 214-3, while other segments 214-2 are left hollow. Additional details regarding the segmented positioning of SMM 210 plugs within the first channel 104 and/or the second channel 106 are depicted below in connection with FIG. 8.

Upon application of the activation input via the electrical source 218, those first channel segments without SMM 210 (i.e., the second segment 214-2) contract before, and to a greater degree, than those first channel segments with SMM 210 (i.e., the first and third segment 214-1 and 214-3) based on the principles described above. Moreover, the portion of the longitudinal body 102 that does not include any SMM 210 (i.e., the portion of the longitudinal body 102 that aligns with the second segment 214-2) may experience a uniform activation input response on account of a single material forming this portion of the longitudinal body 102. Accordingly, this portion of the longitudinal body 102 may uniformly contract and, therefore, not exhibit the bending which may manifest in the other portions of the longitudinal body 102 (i.e., those portions that align with the first and third segments, 214-1 and 214-3, respectively). As such, the shape-changing fiber 200 may exhibit a deformed actuation, as depicted in FIG. 2D.

Still further, the portion of the longitudinal body 102 that aligns with the second segment 214-2 may also be elastically deformable, even when the SMM 210 is cooled. That is, as described above, the SMM 210 may become rigid when below the SMM transition temperature, T_{tSMM}. Accordingly, as no SMM 210 is present in the second segment 214-2, this portion of the shape-changing fiber 200 may remain flexible when cooled, while the portions that align with the first and third segments 214-1 and 214-3 may be rigid and in an example, maintained in a deformed state.

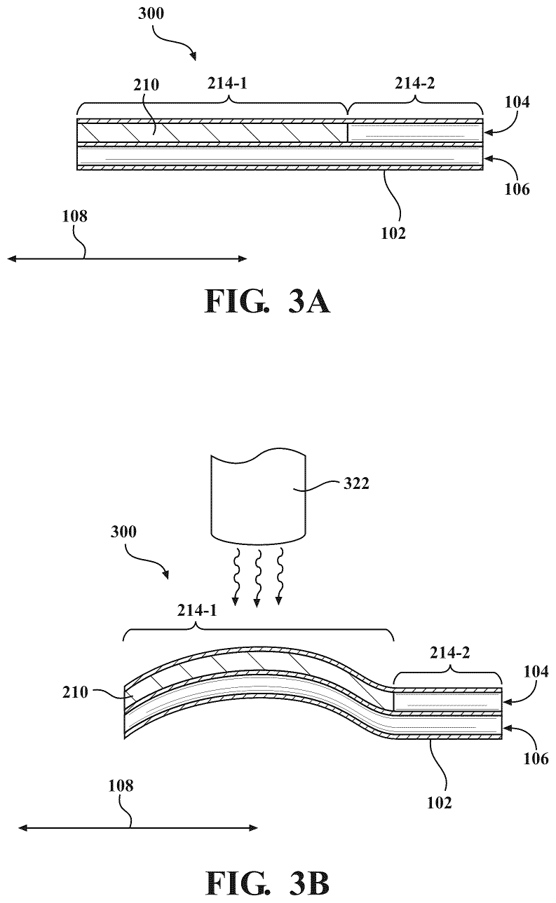

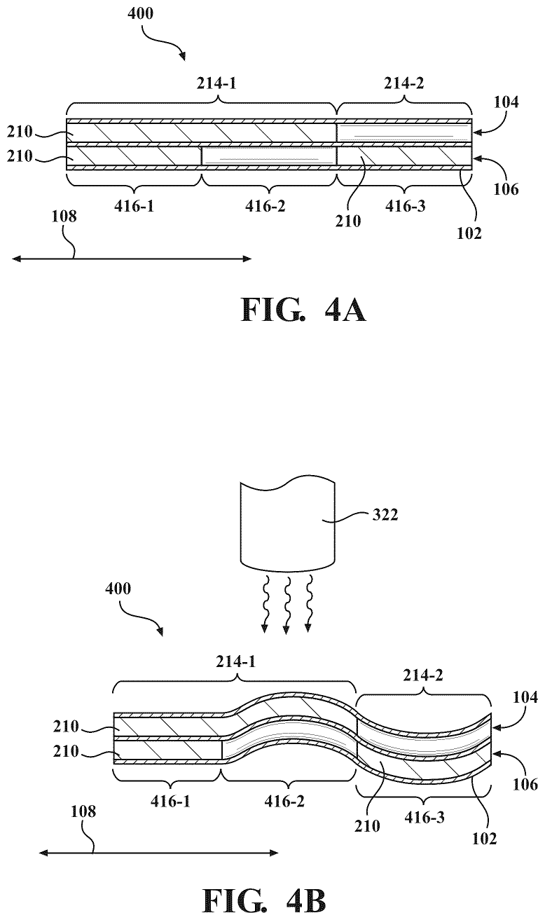

FIGS. 3A and 3B are cross-sectional side views of a shape-changing fiber 300 with SMM 210 in the first channel 104 in accordance with an embodiment described herein. As described above, the bending actuation of the shape-changing fiber 300 may be defined, in part, by the arrangement of SMM 210 plugs in different segments 214-1 and 214-2 of the first channel 104. In the example depicted in FIG. 3A, SMM 210 is positioned just within a first segment 214-1 of the first channel 104 and not within a second segment 214-2 of the first channel 104. Accordingly, upon actuation (in this example via a heating device 322), the portion of the longitudinal body 102 that aligns with the first segment 214-1 may bend, as depicted in FIG. 3B based on the properties of SMM 210 and LCE described above. The portion of the longitudinal body 102 that aligns with the second segment 214-2 may exhibit uniform contraction and, therefore, not a bending actuation. As such, FIGS. 2A-4B depict that different and programmable bending positions/actuations are achievable by selectively placing SMM 210 in different segments 214 of the first channel 104 (and second channel 106 as depicted in FIGS. 4A and 4B).

In the example depicted in FIGS. 3A and 3B, the second channel 106 is left hollow. In this example, rather than heating the SMM 210 and LCE internally via LM 212, the SMM 210 and LCE may be externally heated, for example, via a heating device 322, such as a fan that blows heated air toward the shape-changing fiber 300.

FIGS. 4A and 4B are cross-sectional side views of a shape-changing fiber 400 with SMM 210 in both channels 104 and 106 in accordance with an embodiment described herein.

As described above, SMM 210 may be found in the first channel 104 in a first segmented arrangement. In the example depicted in FIGS. 4A and 4B, the shape-changing fiber 400 may also include SMM 210 in the second channel 106 in a second segmented arrangement that differs from the first segmented arrangement. That is, like the first channel 104, the second channel 106 may be divided into segments 416-1, 416-2, and 416-3. Moreover, like the first channel segments 214, the second channel segments 416-1, 416-2, and 416-3 may include at least one hollow segment 416-2. Additional details regarding the segmented positioning of SMM 210 plugs within the first channel 104 and the second channel 106 are described below in connection with FIG. 7.

Accordingly, upon application of the activation input via the heating device 322, those segments without SMM 210 (i.e., the hollow first channel segment 214-2 and the hollow second channel segment 416-2) contract before and to a greater degree than those segments with SMM 210 (i.e., the filled first channel segment 214-1 and the filled second channel segments 416-1 and 416-3) based on the principles described above. Moreover, the portion of the longitudinal body 102 that aligns with both SMM-filled segments (i.e., the portion of the longitudinal body 102 that corresponds to the filled segment 416-1 of the second channel 106) may experience a uniform activation input response on account of the similar material properties along this section of the longitudinal body 102 in both channels 104 and 106. Accordingly, this portion of the longitudinal body 102 may uniformly contract and, therefore, does not exhibit the bending which may manifest in the other portions of the longitudinal body 102 (i.e., those portions that align with the first and third segments 416-2 and 416-3 of the second channel 106, respectively). As such, the shape-changing fiber 200 may exhibit a deformed state, as depicted in FIG. 4B.

Still further, the portion of the longitudinal body 102 may be rigid when cooled. That is, as described above, the SMM 210 may become rigid when below the SMM transition temperature, T_{tSMM}. Accordingly, as SMM 210 is present in both channels 104 and 106, the longitudinal body 102 may remain rigid when not heated.

Note that while FIGS. 2C-4B depict particular patterned arrangements of SMM 210 plugs in the first channel 104 and the second channel 106, each channel 104 and 106 may be divided into different patterns of filled/unfilled SMM 210 segments to generate an innumerable quantity of bending actuations. That is, the shape-changing fibers depicted herein, based on the channel portions filled with SMM 210 and those that are left hollow, provide a customizable bending actuator.

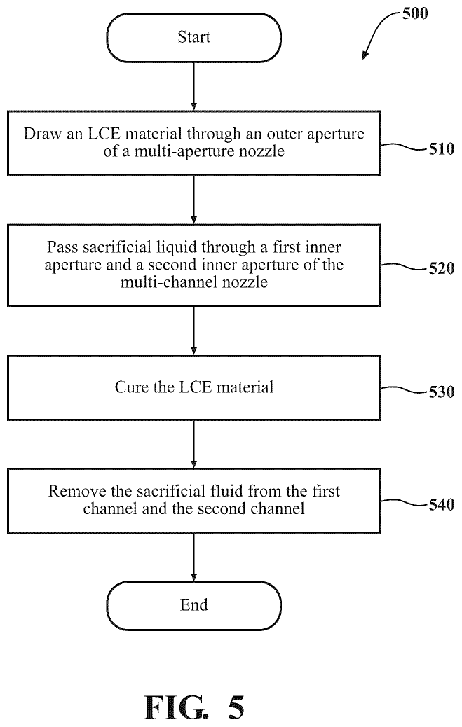

FIG. 5 illustrates a flowchart for one embodiment of a method 500 that is associated with forming a dual channel shape-changing fiber in accordance with an embodiment described herein. As depicted in FIGS. 6B and 6C, a multi-aperture nozzle may facilitate the formation of the dual-channel shape-changing fiber 100 as flowable LCE material (i.e., LCE ink) is extruded around two inner apertures that eject a sacrificial fluid. With the sacrificial fluid in place, the LCE material is partially cured such that upon removal of the sacrificial fluid, hollow channels 104 and 106 remain in the LCE longitudinal body 102. Note that while FIGS. 5-7 describe the formation of a shape-changing fiber 100, the same process may be implemented to form other instances of the shape-changing fiber described herein.

That is, in an example, forming the shape-changing fiber 100 includes co-axial spinning LCE ink with a sacrificial fluid to form an LCE body with two inner channels. As a specific example, LCE diacrylate mesogens and a flexible dithiol chain extender are combined and react to form a linear LCE oligomer ink, which serves as an outer shell fluid during the coaxial spinning. A sacrificial fluid (which may be water due to its inertness with LCE and ease of removal) serves as a core for the two inner channels. Co-extrusion of the LCE ink and sacrificial fluid through a coaxial multi-aperture nozzle, with subsequent removal of the sacrificial fluid (e.g., the water), forms the shape-changing fiber 100. Exposure to ultraviolet (UV) light cures the LCE material, providing a mechanically robust dual-channel LCE fiber.

Accordingly, the method 500 includes, at 510 and 520, simultaneously 1) drawing an LCE ink through an outer aperture of a multi-aperture nozzle to form a longitudinal body 102 and 2) passing a sacrificial fluid through a first inner aperture and a second inner aperture of the multi-aperture nozzle to form inner channels 104 and 106 within the longitudinal body 102. That is, both the LCE material and the sacrificial fluid may be flowable or made to be flowable. As described above and as depicted in FIGS. 6A-6C , the outer aperture is coaxial to and surrounds the first and second inner apertures. In an example, the extrusion of the LCE ink is regulated by maintaining a target pressure, P, and a flow rate, Q, of the sacrificial fluid is adjusted via a syringe pump.

At 530, the LCE ink is cured. In one example, curing may be done via a UV light source to induce UV crosslinking and fix the fibrous shape and mesogen alignment of the LCE material. It may be the case that the LCE may not be fully crosslinked at this stage. Accordingly, curing the LCE material may include a second stage, which may occur following the removal of the sacrificial fluid, to result in the final mechanically robust shape-changing fiber 100.

Once cured, at 540, the sacrificial fluid is removed from the first channel 104 and the second channel 106. For example, gas blowing and vacuum drying removes water from the LCE material, resulting in the aforementioned first channel 104 and second channel 106. As described above, in some examples, at least one of the channels 104 and 106 may be left hollow, as depicted in FIGS. 3A and 3B. In other examples, such as those depicted in FIGS. 2A-4B , at least one channel may be filled (completely or partially) with SMM 210 or an activating material such as LM 212. As described above, the SMM 210, in whatever segmented pattern it is injected into channels 104 and 106, may trigger a particular bending actuation of the shape-changing fiber 100. Moreover, the LM 212, if desired, may provide the property change-inducing actuation input (e.g., heat) to the SMM 210 and LCE from the inside.

FIGS. 6A-6C illustrate a manufacturing system 624 for forming a dual channel shape-changing fiber 100 in accordance with an embodiment described herein. Specifically, FIG. 6A depicts the manufacturing system 624, FIG. 6B depicts a zoomed-in view of the multi-aperture nozzle 626, and FIG. 6C depicts a cross-sectional view of the multi-aperture nozzle 626. As described above, the shape-changing fiber is manufactured via coaxial spinning. Specifically, a sacrificial fluid, such as water 628, is contained in two syringe pumps 630-1 and 630-2, each associated with a respective to-be-formed channel 104 and 106. Fluidized, uncured LCE ink 632 is contained within an LCE syringe pump 634. Via action of the syringe pumps 630-1 and 630-2 and LCE syringe pump 634, the LCE ink 632 and the water 628 may be directed to the multi-aperture nozzle 626 highlighted in FIGS. 6B and 6C.

In an example, the LCE ink 632 may be extruded from the LCE syringe pump 634 at a pressure of between 20 and 40 pounds per square inch (psi), for example, 30 psi at ambient temperature. Water 628 may be ejected from the syringe pumps 630-1 and 630-1 at a rate of between, for example, 0.10 millimeters per minute (mL/min) and 0.30 mL.

At the multi-aperture nozzle 626, water 628 flows through inner apertures 636-1 and 636-2, while the LCE ink 632 flows through an outer aperture 638. That is, the multi-aperture nozzle 626 may include inner apertures 636-1 and 636-2 surrounded by an outer ovular or ring-shaped aperture 638. In an example, the inner apertures 636-1 and 636-2 may have outside diameters of between 0.2 mm to 0.5 mm, and the outer aperture 638 may have an outside major diameter of between 0.5 mm to 1.2 mm and an outside minor diameter of 0.4 mm to 0.9 mm. Note that while FIGS. 6B and 6C depict particular shapes and sizes for the inner apertures 636-1 and 636-2 and the outer aperture 638, these apertures may have different shapes and sizes based on the desired dimensions of the longitudinal body 102 and first and second channels 104 and 106.

Upon extrusion, the shape-changing fiber 100 may be subjected to mechanical stretching by a roller 640, which collects the shape-changing fiber 100 and may rotate at a draw speed, v, of between 50 centimeters per minute (cm/min) and 100 cm/min. This roller 640 collects the shape-changing fiber 100 and induces thinning of the shape-changing fiber 100. Through this process, the LCE mesogens may be aligned by shearing in the outer aperture 638 of the multi-aperture nozzle 626 and stretching due to the discrepancy between the draw and extrusion speeds.

Note that the dimensions of the shape-changing fiber 100, including the longitudinal body diameter and channel diameters, are dependent upon the ink pressure, P; sacrificial fluid flow rate, Q; draw speed, v; and the dimensions of the apertures of the multi-aperture nozzle 626. Specifically, for a constant draw speed, v, and ink pressure, P, increasing the sacrificial fluid flow rate, Q, increases the inside diameter of the first and second channels 104 and 106. By comparison, the outside diameter of the longitudinal body 102 may not vary given different sacrificial fluid flow rates, Q.

For a constant sacrificial fluid flow rate, Q, and ink pressure, P, increasing the draw speed, v, decreases the outside diameter of the longitudinal body 102 and the first and second channels 104 and 106. Accordingly, the manufacturing system 624 facilitates flexibility and customization in fabricating shape-changing fibers 100 with tailored dimensions and sizes.

Returning to the manufacturing operation, during extrusion, the shape-changing fiber 100 may be subjected to UV curing from a UV light source 642. In an example, the shape-changing fiber 100 may be subjected to UV light having a wavelength of between 300 and 500 nanometers (nm), for example, 390 nanometers nm, at an intensity of between 40 and 60 milliwatts per square centimeter (mW/cm²), for example, 50 mW/cm².

The sacrificial fluid may be removed after extrusion and collection of the shape-changing fiber 100 on the roller 640. Specifically, in an example, the shape-changing fiber 100 may undergo a gas-blowing process where air is forced through the first and second channels 104 and 106 to expel the sacrificial fluid. To eliminate residual sacrificial fluid, the shape-changing fiber 100 may be exposed to a heat source 644 (e.g., in an oven) at over 30 degrees Celsius. As described above, it may be that the first stage of UV curing does not entirely cure the shape-changing fiber 100. Accordingly, in some examples, the shape-changing fiber 100 may be subject to a second phase of UV exposure.

As such, a customizable dual-channel shape-changing fiber 100 is produced. As depicted above and as described below in connection with FIG. 7, the different channels 104 and 106 may be filled with different functional materials to produce a shape-changing, and in some examples, a deformable shape-retaining fiber.

FIG. 7 illustrates a flowchart for one embodiment of a method 700 that is associated with forming a dual channel-shape changing fiber in accordance with an embodiment described herein.

As described above, the physical dimensions of the shape-changing fiber may be based on a variety of factors, including the diameters of the inner apertures 636-1 and 636-2 and the outer aperture 638, as well as the ink pressure, P, sacrificial fluid flow rate, Q, and roller 640 draw speed, v. Accordingly, at 710, the method 700 includes selecting a target diameter for the inner channels 104 and 106 and a target diameter for the longitudinal body 102 and setting at least one of the draw speed, v, sacrificial fluid flow rate, Q, and ink pressure, P, based on the target diameters. In some examples, the relationship between these variables and the dimensions of the shape-changing fiber may be determined empirically or stored in a database that may be referenced when programming the manufacturing system 624. Either way, the manufacturing system 624 described herein provides customization and tailoring of the shape-changing fiber to meet any application criteria.

At 720 and 730, the method 700 includes simultaneously 1) drawing an LCE ink 632 through the outer aperture 638 of the multi-aperture nozzle 626 and 2) passing sacrificial fluid, such as water 628, through a first inner aperture 636-1 and a second inner aperture 636-2 of the multi-aperture nozzle 626. At 740, as described above, the method 700 may include curing the LCE material by exposing the shape-changing fiber to UV light from the UV light source 642 during extrusion. At 750, as described above, the sacrificial fluid is removed from the respective channels 104 and 106 by, for example, blowing gas, such as air, through the channels 104 and 106 and/or evaporating any residual sacrificial fluid via heating, such as in an oven.

As described above, in some examples, one or more of the channels 104 and 106 may be filled with different functional materials, whether SMM 210 to induce bending (and potentially shape locking) or an activating material such as LM 212 to provide the activation input to the SMM 210 and LCE. Accordingly, at 760, the method 700 includes injecting SMM 210 within the first channel 104, where a property of the SMM 210 reversibly changes responsive to the activation input to a different degree than how the shape property of the LCE material reversibly changes responsive to the activation input.

In an example, the SMM 210 is injected into the first channel 104 in a segmented arrangement where plugs of SMM 210 may be spaced apart from one another in the first channel 104. A detailed example of generating spaced-apart SMM 210 plugs will now be provided. In this example, SMM 210 is injected into a first segment of the first channel 104 (e.g., the first segment 214-1 depicted in FIG. 2C) until it reaches a predetermined location (i.e., where a predetermined bending actuation is desired). The amount of SMM 210 injected into the first channel 104 may be based on the desired radius of curvature of the bending actuation. Note also that the SMM 210 may be fluidized or soft at this stage. Specifically, the SMM 210 may be heated to be flowable and injected into the first channel 104. Once the SMM 210 is in the desired location (e.g., the first segment 214-1 of the first channel 104), the SMM 210 may be cured such that it hardens into an unflowable but shape-changing mass. Following curing, a second portion of flowable or soft SMM 210 is injected into the respective channel (e.g., the first channel 104) to a second segment (e.g., the third segment 214-3 of the first channel 104). Note that in this example, as the fluid SMM 210 is injected into the first channel 104, the air within the first channel 104 is evacuated in the opposite direction, i.e., towards a port through which the SMM 210 is injected. Via any number of injection/curing cycles, several SMM plugs or segments may be distributed throughout the first channel 104. In one particular example, before and after the injection of SMM 210 to a particular segment 214, clamps may be placed at either end of already placed SMM 210 plugs to ensure that they do not move during the placement of a subsequent SMM 210 plug. Note that during insertion/curing of the SMM 210 plugs, the SMM 210 may be chemically bonded (e.g., via acrylate bonding) to the surrounding LCE to induce the bending.

At 770, the method 700 includes injecting an activating material such as LM 212 or SMM 210 into the second channel 106. Specifically, as depicted in FIGS. 2A-2D , the LM 212 may be injected into the second channel 106, which LM 212 may heat in response to an applied electrical current. As described above, heating the LM 212 heats the adjacent LCE and SMM 210 to achieve the desired actuation.

In another example, SMM 210 may be injected into the second channel 106. As depicted in FIGS. 4A and 4B, the SMM 210 may be injected into the first channel 104 in a first segmented arrangement and into the second channel 106 in a second segmented arrangement that is different than the first segmented arrangement that is different. The positioning of SMM 210 plugs within the second channel 106 may be performed as described above regarding the placement of SMM 210 plugs within the first channel 104. A direction of the bending actuation at a particular location along the longitudinal body 102 may be defined by which of the first channel 104 and the second channel 106 receives the SMM 210. Characteristics of the bending actuation (e.g., a radius of curvature) may be based on the amount of SMM 210 injected at the particular location.

Accordingly, the shape-changing fiber is ready to be actuated at this stage. Accordingly, at 780, an activation input is applied to the LCE material and the SMM 210 to bend the longitudinal body 102. As described above, the bending of the shape-changing fiber results from the different actuation responses/strains of the SMM 210 and the LCE. In an example, the activation input may be supplied as an electrical current from the electrical source 218 through the LM 212 or via an external heat source 322. An example electrical current may be between 3 and 5 amperes (A), for example, 4 A, with an example voltage of between 1-3 volts (V), for example, 2 V.

At a subsequent point in time, at 790, the activation input may be removed to either 1) return the shape-changing fiber to an undeformed shape or 2) lock the shape-changing fiber in a deformed state.

As described above, the SMM 210 becomes soft and pliable when activated. However, the SMM 210 may be rigid and stiff when not activated. Based on the parameters of the discontinuance of the activation input, the shape-changing fiber may be locked in a deformed state or returned to an undeformed state. Specifically, the SMM 210 may transition from a rigid state to a pliable state at an SMM transition temperature, T_{tSMM}, and the LCE may transition from a nematic (e.g., uncontracted) state to an isotropic (e.g., contracted) state at an LCE transition temperature, T_{tLCE}. As described above, an example SMM transition temperature, T_{tSMM}, may be between 20 and 120 C. An example LCE transition temperature, T_{tLCE} may be between 50 and 90 C.

In an example, the SMM transition temperature, T_{tSMM} (e.g., 60 C), may be lower than the LCE transition temperature, T_{tLCE,} such that upon heating, the SMM storage modulus (i.e., a material property that measures how much energy a material can store and recover elastically) is reduced before that of the LCE on account of the fiber temperature passing the SMM transition temperature, T_{tSMM}, before the LCE transition temperature, T_{tLCE}. That is, the SMM 210 becomes pliable before the LCE contracts. Accordingly, when the LCE begins to contract during heating, the SMM 210 does not resist the contraction, and the shape-changing fiber as a whole contracts/bends as described above.

If the activation input is removed slowly and uniformly, the LCE longitudinal body and the SMM 210 may cool at the same rate. As such, the LCE will fall below the LCE transition temperature, T_{tLCE}, and begin to extend while the SMM 210 is still in its pliable stage (i.e., the SMM 210 is still above the SMM transition temperature). As such, the LCE and the SMM 210 will recover to their original shape during cooling.

If the activation input is removed quickly, the SMM 210 may fall below the SMM transition temperature, T_{tSMM}, before the LCE falls below the LCE transition temperature, T_{tLCE}, on account of the different thermal conductive properties of SMM 210 and LCE. Accordingly, the SMM 210 may become rigid before the LCE expands. In this example, the rigidity of the SMM 210 overcomes the LCE expansion such that the shape-changing fiber does not return to its original shape but remains deformed. That is, the contraction of the LCE cannot drive the rigid SMM 210. Thus, the shape-changing fiber is locked in a deformed state. As such, based on the cooling parameters, the shape-changing fiber may be either locked in a deformed state or returned to its original form.

In one example, cooling the SMM 210 may be facilitated by adding a channel within the SMM 210 itself. That is to say, as depicted in FIG. 8 below, the SMM 210 1) may be placed within a channel 104 or 106 and 2) may include a channel 846. Through the SMM channel 846, a cooling liquid, such as water, may be pumped to cool the SMM 210 more quickly than the surrounding LCE longitudinal body 102. In this example, the hollowed SMM 210 may be inserted into the longitudinal body 102, as described above, by being heated to a state where it can be inserted into the channel 104 and 106 while retaining its hollow form.

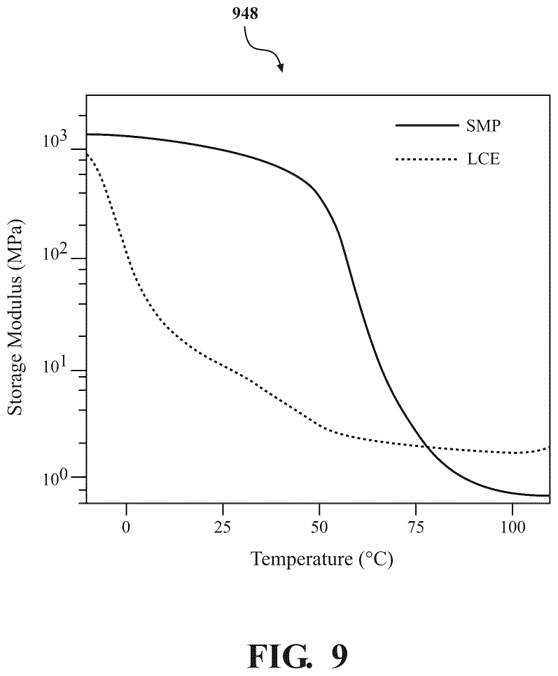

FIG. 9 is a graph 948 depicting the storage modulus of a shape-changing fiber with SMM 210 disposed therein. As described above, storage modulus is a material property that measures how much energy a material can store and recover elastically during each cycle. Put another way, the storage modulus indicates a material's solid or elastic nature. The graph 948 depicts the change in storage modulus of SMM 210 and LCE across different temperatures. As depicted in the graph 948, in the SMM-dominated region, the storage modulus of SMM 210 is higher than that of LCE. Accordingly, while in this temperature range, the shape-changing fiber is rigid and dominated by the SMM 210. As the temperature increases, the SMM 210 modulus is reduced to lower than that of the LCE. As the LCE is to contract when above this temperature, and the LCE is tightly bound to the soft SMM, the LCE will drive the SMM to contract along with the LCE.

As described above, the temperature at which the LCE transitions to an isotropic state, i.e., the T_{tLCE}, should be higher than the temperature at which the system changes from SMM-dominated to LCE-dominated.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of ... and ....” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

Aspects herein can be embodied in other forms without departing from the spirit or essential attributes thereof. Accordingly, reference should be made to the following claims, rather than to the foregoing specification, as indicating the scope hereof.

What is claimed is:

1. A shape-changing fiber, comprising:
a longitudinal body of a liquid crystal elastomer (LCE) material, a shape property of the LCE material reversibly changes responsive to an activation input;
a first channel formed longitudinally within the longitudinal body; and
a second channel formed longitudinally within the longitudinal body, the first channel and the second channel are parallel to one another.

2. The shape-changing fiber of claim 1, further comprising shape memory material (SMM) within the first channel, a shape property of the SMM reversibly changes responsive to the activation input to a different degree than the shape property of the LCE material.

3. The shape-changing fiber of claim 2, further comprising an activating material within the second channel.

4. The shape-changing fiber of claim 3, wherein the activating material is liquid metal.

5. The shape-changing fiber of claim 3, further comprising an electrical source to apply the activation input to the activating material.

6. The shape-changing fiber of claim 2, wherein the SMM within the first channel is formed in a first segmented arrangement.

7. The shape-changing fiber of claim 6, further comprising SMM within the second channel in a second segmented arrangement that differs from the first segmented arrangement.

8. The shape-changing fiber of claim 7, wherein at least one of the first segmented arrangement of the SMM within the first channel or the second segmented arrangement of the SMM within the second channel comprises hollow segments.

9. The shape-changing fiber of claim 2, wherein the SMM comprises an SMM channel through which a cooling liquid is passed.

10. A shape-changing fiber, comprising:
a longitudinal body of a liquid crystal elastomer (LCE) material, a shape property of the LCE material reversibly changes responsive to an activation input;
a first channel formed longitudinally within the longitudinal body;
a second channel formed longitudinally within the longitudinal body, the first channel and the second channel are parallel to one another; and
shape memory material (SMM) within the first channel, a shape property of the SMM reversibly changes responsive to the activation input, to a different degree than the shape property of the LCE material.

11. The shape-changing fiber of claim 10, further comprising an activating material within the second channel.

12. The shape-changing fiber of claim 11, further comprising an electrical source to apply the activation input to the activating material.

13. The shape-changing fiber of claim 10:
wherein the SMM within the first channel is formed in a first segmented arrangement; and
further comprising SMM within the second channel in a second segmented arrangement that differs from the first segmented arrangement.

14. A method of forming a shape-changing fiber, comprising:
simultaneously:
drawing a liquid crystal elastomer (LCE) material through an outer aperture of a multi-aperture nozzle to form a longitudinal body, a shape property of the LCE material reversibly changes responsive to an activation input; and
passing a sacrificial fluid through a first inner aperture and a second inner aperture of the multi-aperture nozzle to form inner channels within the longitudinal body, the outer aperture is coaxial to and surrounds the first inner aperture and the second inner aperture;
curing the LCE material; and
removing the sacrificial fluid from a first channel and a second channel.

15. The method of claim 14, further comprising injecting shape memory material (SMM) within the first channel, a property of the SMM reversibly changes responsive to the activation input, to a different degree than the shape property of the LCE material.

16. The method of claim 15, further comprising injecting an activating material within the second channel.

17. The method of claim 15, wherein:
injecting the SMM within the first channel comprises injecting the SMM within the first channel in a first segmented arrangement;
the method further comprises injecting SMM within the second channel in a second segmented arrangement that differs from the first segmented arrangement; and
at least one of the first segmented arrangement and the second segmented arrangement comprises hollow segments.

18. The method of claim 17, wherein injecting SMM within a respective channel in a segmented arrangement comprises:
injecting SMM into the respective channel to a first segment;
curing the SMM to form an SMM plug; and
injecting SMM into the respective channel to a second segment.

19. The method of claim 15, further comprising applying the activation input to the LCE material and the SMM to bend the longitudinal body on account of different responses to the activation input.

20. The method of claim 14, further comprising:
selecting a target diameter for the inner channels and a target diameter for the longitudinal body; and
setting at least one of a draw speed, sacrificial fluid flow rate, and ink pressure based on the target diameters.
